(19) United States
(12) Patent Application Publication
(10) Pub. No.: US 2025/0024859 A1
(43) Pub. Date: Jan. 23, 2025

(54) Feed Formulations for Farmed Shrimps

(71) Applicant: AllSustained, LLC, Shrewsbury, MA (US)

(72) Inventors: Amir SABERI, Shrewsbury, MA (US); Khaled SADEGHI, Isfahan (IR)

(21) Appl. No.: 18/775,008

(22) Filed: Jul. 17, 2024

Related U.S. Application Data
(60) Provisional application No. 63/527,912, filed on Jul. 20, 2023.

(51) Int. Cl. A23K 10/37; A23K 10/22; A23K 10/30; A23K 50/80

(52) U.S. Cl. CPC A23K 10/37; A23K 10/22; A23K 10/30; A23K 50/80

(57) ABSTRACT

In one aspect, a feed formulation for farmed shrimps is disclosed, which includes corn steep liquor (CSL), and a source of protein. By way of example, the source of protein can be any of an animal-based and a plant-based source of protein. Some suitable examples of the source of protein can include, without limitation, fishmeal, soybean meal (SBM), extruded soy, a combination of fishmeal and SBM. Further, in various embodiments, the source of protein can include a combination of SBM and another source of protein. In various embodiments, the source of protein can include any of wheat, gluten and corn gluten. Another example of the source of protein includes an animal byproduct, which can be, for example, in the form of a powder.

### CROSS REFERENCE TO RELATED APPLICATIONS

This application is a non-provisional application of U.S. provisional application No. 63/527,912 filed Jul. 20, 2023, the entirety of which is incorporated herein by reference.

### BACKGROUND

The present disclosure is generally directed to feed formulations for farmed shrimps.

Consumption of seafood per capita in the U.S. has slightly decreased over the past few years. Notwithstanding, the consumption of certain seafood species, and in particular shrimps, has increased. For example, the U.S. shrimp market in 2020 reached about 750 kilo tons. A large percentage of shrimps consumed globally constitutes farmed shrimps.

As such, there is a need for enhanced feed formulations for feeding farmed shrimps.

### SUMMARY

In one aspect, a feed formulation for farmed shrimps is disclosed, which includes corn steep liquor (CSL), and a source of protein. By way of example, the source of protein can be any of an animal-based and a plant-based source of protein. Some suitable examples of the source of protein can include, without limitation, fishmeal, soybean meal (SBM), extruded soy, a combination of fishmeal and SBM. Further, in various embodiments, the source of protein can include a combination of SBM and another source of protein. In various embodiments, the source of protein can include any of wheat, gluten and corn gluten. Another example of the source of protein includes an animal byproduct, which can be, for example, in the form of a powder.

The concentration of the CSL in the feed formulation can be, for example, in a range of about 10% to about 90%, such as in a range of about 20% to about 80%, or in a range of about 30% to about 70%, or in a range of about 40% to about 60%, such as 50%.

In various embodiments, the feed formulation can further include at least one of an animal-based or a plant-based oil. By way of example, and without limitation, the plant-based oil can be soybean oil and the animal-based oil can be fish oil.

In various embodiments, the source of protein can be an untreated source of protein, such as untreated soy.

In a related aspect, a method of enhancing survival rate of farmed shrimps is disclosed, which comprises feeding a population of farmed shrimps, over at least a portion of a lifecycle thereof, with a feed formulation comprising corn steep liquor (CSL) and a source of protein. In some embodiments, the survival rate of the farmed shrimps is extended by at least about 10% relative to a control population of farmed shrimps being fed a feed formulation lacking CSL. The lifecycle of farmed shrimps can extend over a temporal period in a range of about 3 to about 6 months. In some cases, at least a portion of the lifecycle can include a period in a range of about 5% to about 100% to the lifecycle.

In a related aspect, a method of feeding farmed shrimps is disclosed, which includes feeding the farmed shrimps over at least a portion of a lifecycle thereof a feed formulation comprising CSL and a source of protein.

### BRIEF DESCRIPTION OF THE DRAWINGS

FIG. 1 shows comparative survival rate data for farmed shrimps exposed to Vibrio parahaemolyticu bacteria, where the control group was fed a conventional feed formulation and the test group was fed a feed formulation according to an embodiment of the present teachings,

FIG. 2 shows comparative survival rate data for farmed shrimps subjected to hypoxia stress, where the control group was fed a conventional feed formulation and the test group was fed a feed formulation according to an embodiment of the present teachings, and

FIG. 3 is a flow chart depicting various steps in an embodiment for producing a feed formulation according to the present teachings.

### DETAILED DESCRIPTION

Shrimps (known also under the scientific term Cardea) are crustaceans and are closely related to other crustacean animals, such as crabs, crayfish, and lobsters. A shrimp is defined as a “decapod crustacean of the suborder Natantia.” There are over 300 subspecies of shrimp, and each one has its own scientific name. Some examples of shrimp species include Penaeus vannamei (Pacific white shrimp), Penaeus monodon (giant tiger prawn), and Metapenaeus dobsoni (Kadal shrimp)

It has been unexpectedly discovered that incorporating corn steep liquor (CSL) in the feed for farmed shrimps can lead to several significant advantages. For example, the incorporation of CSL in the feed can enhance the survivability of the shrimps when exposed to adverse environmental conditions, such as pathogenic bacteria, hypoxia, among others. In addition, it has been unexpectedly found that the incorporation of CSL in the feed allows for a wider selection of proteins in the feed. For example, traditionally, certain protein sources, such as soy, are treated to remove anti-nutritional factors, thereby significantly increasing the production cost. In contrast, in various embodiments, the incorporation of the CSL in the feed formulation allows the use of untreated protein sources in the feed formulation without causing an adverse effect, and in fact enhancing the survivability of shrimps, as discussed in more detail below.

Corn steep liquor (CSL), which is also known as corn steep water, is a by-product of wet milling process of maize starch. It includes water-soluble extracts of corn, steeped in water and it is in the form of brown viscous liquid. It is an excellent source of proteins, amino acids, minerals, vitamins, reducing sugars, organic acids, such as lactic acid, enzymes, among other nutrients. It is important to note that like all feed ingredients, the use of CSL in a feed formulation needs to be carefully balanced with other ingredients to meet the nutritional requirements of the target species without exceeding their tolerance for certain nutrients.

There have been reports of the use of CSL as a supplementary feed for certain species of fish. For example, there have been suggestions for using CSL as a partial replacement of fish meal in the feed for certain species of fish. However, different aquatic species have different nutritional needs and hence a nutritional ingredient that may be suitable, or even advantageous, for one species may not be suitable, or even be harmful, to another species. Further, the interaction of different ingredients in a feed formulation, which can be difficult to predict, can affect the suitability of that ingredient for use in the feed formulation.

As discussed in more detail below, in various embodiments, in a feed formulation according to the present teachings, in addition to the incorporation of CSL in the feed formulation, the formulation can include fish meal, a high grade protein that is highly digestible and does not appear to include anti-nutritional factors that would require removal via processing as well as soybean meal. Soybean meal, while a more abundant and sustainable alternative to fish meal, has antinutritional factors that can hinder digestion and cause gastrointestinal issues. However, in various embodiments, the use of CSL allows incorporating untreated soybean meal in the formulation. As such, in some embodiments, untreated soybean can be employed in a formulation together with CSL, either as the only high-grade protein or in combination with another high grade protein, such as fish meal.

Not only does the use of untreated protein in the feed formulation reduce the production cost, but also it has been unexpectedly discovered that such feed formulations enhance the survivability of farmed shrimps when exposed to challenging environments. For example, in one embodiment, the feed formulation can contain CSL and untreated soy, though other ingredients such as those discussed below can also be added. Soybeans are known to contain a significant amount of antinutritional factors. Therefore, one would have considered a feed formulation having such anti-nutritional factors as not providing any benefit, and in fact as being disadvantageous. However, as noted above, it has been discovered that feed formulations having CSL and untreated soy can in fact enhance survival rate of farmed shrimps.

Various terms are used herein in accordance with their ordinary meanings in the art. The term “antinutritional factors” and its abbreviation “ANFs” refer to substances that, when present in animal feeds, may interfere with digestion, absorption, or utilization of nutrients. They can be found in a variety of feed ingredients, including soy. Several ANFs present in soy can have negative impacts on shrimps. For example, soy contains substances known as trypsin inhibitors, which can inhibit the action of trypsin, an important digestive enzyme in shrimps. The inhibition of trypsin can lead to reduced protein digestibility and growth rate. These inhibitors can be deactivated by heat treatment. Soy has also a high content of phytic acid, which can reduce the bioavailability of important minerals such as calcium, magnesium, iron, and zinc. This is due to phytic acid's ability to form insoluble complexes with these minerals. Enzyme supplementation (like phytase) is one of the strategies to mitigate the effect of phytic acid. Saponins include other compounds that can disrupt the mucosal layer of the gut, reducing nutrient absorption and potentially leading to gut inflammation. They can also decrease the palatability of feeds, which can reduce feed intake and growth.

Lectins are proteins that can bind to the sugar molecules on the surface of cells, leading to agglutination (clumping together). In shrimps, lectins may bind to the intestinal cells, potentially damaging the gut lining and reducing nutrient absorption. Further, soybeans contain non-digestible oligosaccharides (like stachyose and raffinose) which can lead to bloating and flatulence due to their fermentation by gut microbiota.

Various processing techniques, such as roasting, cooking, extrusion, fermentation, and enzymatic treatment can be used to substantially reduce or eliminate these antinutritional factors. Proper processing is crucial when using soy products in conventional aquaculture feeds to ensure maximum nutrient availability and to avoid potential health issues associated with ANFs. However, these processing methods also add to the cost of the feed.

The terms “untreated source of protein” and “untreated protein” are used herein interchangeably to refer to a source of protein, such as soy, that has not been subjected to fermentation and/or enzyme treatment. In some cases, the concentration of certain oligosaccharides, such as stachyose and raffinose, in an untreated source of protein can be significantly greater than in a treated source of protein. For example, in some cases, the concentration of such oligosaccharides in a treated source of protein may be in the range of about 1 to 2 percent while the respective concentrations in a treated source of protein may be 5 to 6 percent.

The term “about” is used herein to indicate a deviation of at most 10% around a numerical value. The term “substantially” is used herein to indicate a deviation, if any, from a complete state or condition of at most 10%.

In various embodiments, a feed formulation for farmed shrimps according to the present teachings can include CSL and a source of protein, such as an untreated source of protein. In some embodiments, the source of protein can be eliminated and the CSL can form the only ingredient of the feed formulation. More typically, the weight concentration of the CSL in the feed formulation can be in a range of about 5% to about 90%, such as in a range of about 10% to about 80%, or in a range of about 20% to about 70%, or in a range of about 30% to about 60%, or in a range of about 40% to about 50%. In various embodiments, the concentration of the CSL in the feed formulation can be greater than about 50%.

In some embodiments, the source of protein can constitute the rest of the feed formulation. For example, the source of the protein can be in the range of about 10% to about 90%, or in a range of about 20% to about 80%, or in a range of about 30% to about 70%. More typically, the concentration of the source of protein in the feed formulation can be in a range of about 25% to about 40%.

As noted above, the source of protein can be animal-based or plant-based, such as those indicated above, such as fish meal, soybean meal, or other animal-based or plant-based proteins. In some embodiments, the source of protein can be full fat soy.

In various embodiments, in addition to the CSL and another source of protein, the feed formulation can further include any of lipids, vitamins and minerals, binder, and additives. Additionally, various conventional sources of carbohydrates, wheat flour, corn or other grains can be incorporated in the feed formulation. Lipids, such as fish oil, can provide a concentrated source of energy. Vitamins and minerals are needed for physiological functions. Binders can be used to hold the feed together and prevent it from disintegrating in water. Some examples of suitable binders include, without limitation, wheat gluten and starch.

Further, as noted above, in various embodiments, additives can also be added to the feed formulation. Some examples of such additives include pigments, e.g., to enhance the color of the shrimp, probiotics, e.g., to improve gut health and immune function, and antimicrobial agents.

In some embodiments, the source of protein that is incorporated into the feed formulation in addition to CSL can be an untreated source of protein, as defined above. In particular, as noted above, the incorporation of the CSL in the feed formulation advantageously allows the use of untreated sources of protein in various embodiments of feed formulation according to the present teachings, which can significantly reduce the production cost.

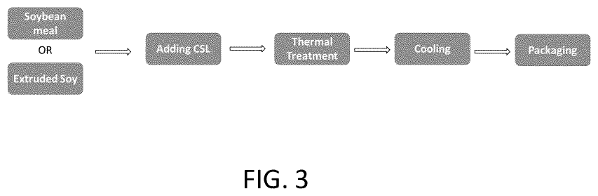

In one method of producing a feed formulation according to an embodiment, CSL can be mixed with a source of protein and other ingredients, such as those discussed above, can be optionally added to the mixture. By way of example, with reference to the flow chart of FIG. 3, in various embodiments, the source of protein (e.g., soybean meal or extruded soy) can be mixed with CSL and the mixture can be subjected to a heat treatment. By way of example, the source of protein can be subjected to an elevated temperature in a range of about 70° C. to about 150° C. Subsequently, the mixture can be cooled, and optionally packaged.

The following example is provided for elucidating various aspects of the present teachings and is not intended to provide necessarily the optimal ways of practicing the invention and/or optimal results that may be obtained.

### EXAMPLES

### Example 1

Feed formulations for feeding farmed shrimps as indicated in Table 1 below were formed. SFS in the Table below refers to a blend of soybean meal and CSL that has undergone thermal process.

TABLE 1

| Feed | Control | 22.5% fishmeal | 36.5% fishmeal |
|---|---|---|---|
| Ingredients | (%) | replacement with SFS | replacement with SFS |
| Fishmeal | 36 | 27.8 | 22.8 |
| Soybean | 25 | 26.2 | 26.2 |
| Wheat flour | 17 | 18 | 14 |
| Corn gluten | 1 | 5 | 8 |
| Wheat gluten | 2 | 6 | 7 |
| Shrimp meal | 10 | 5 | 5 |
| by-products | | | |
| SFS | 10 | 5 | 5 |
| Rice bran | 3.8 | 0.8 | 0.8 |
| Vitamin premix | 0.25% | 0.25% | 0.25% |
| Mineral premix | 0.25% | 0.25% | 0.25% |

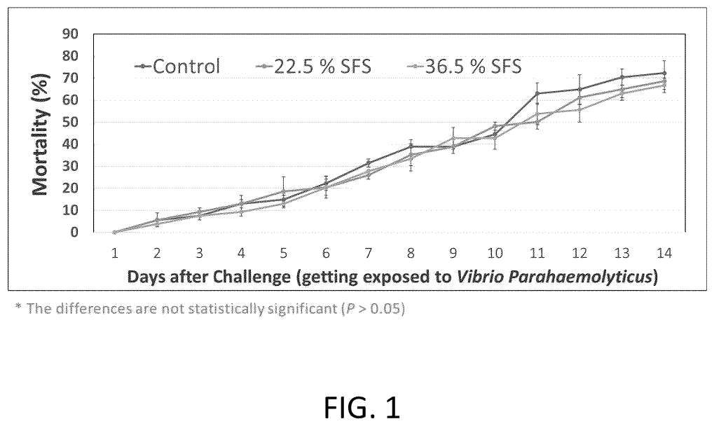

The farmed shrimps were subjected to a hypoxic stress while being fed the above feed formulations. As shown in the data presented in FIG. 1, the incorporation of the CSL in the feed formulations resulted in a statistically significant reduction (P<0.05) in the mortality rate from 80% to 60% over a seven-day period of hypoxic stress.

### Example 2

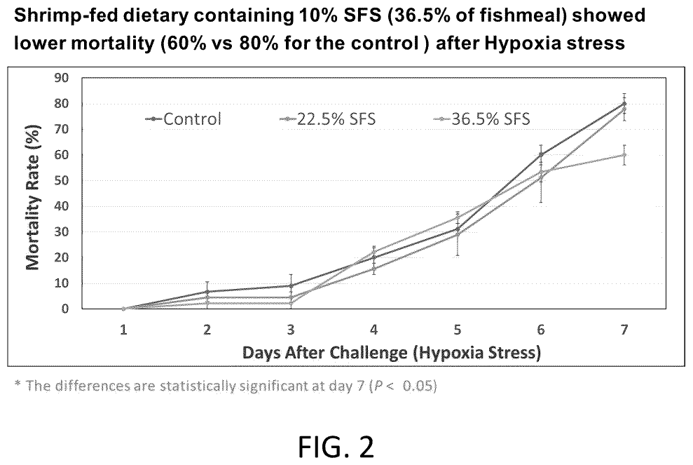

In another experiment, a population of farmed shrimps were subjected to a 14-day Vibrio parahaemolyticus challenge while being fed the feed formulations described above in Example 1. As shown in the data presented in FIG. 2, the incorporation of the CSL in the feed formulations resulted in a decrease in the shrimp mortality rate from 72% to 66%. However, in this case, the observations did not reach a level of statistical significance.

Those having ordinary skill in the art will appreciate that various changes can be made to the above embodiments without departing from the scope of the present invention.

What is claimed is:

1. A feed formulation for farm shrimp, comprising:
corn steep liquor (CSL), and
a source of protein.

2. The feed formulation of claim 1, wherein said source of protein is selected from the group consisting of an animal-based and a plant-based source of protein.

3. The feed formulation of claim 1, wherein said source of protein comprises fishmeal.

4. The feed formulation of claim 1, wherein said source of protein comprises soy bean meal (SBM).

5. The feed formulation of claim 1, wherein said source of protein comprises extruded soy.

6. The feed formulation of claim 1, wherein said source of protein comprises a combination of fishmeal and SBM.

7. The feed formulation of claim 1, wherein said source of protein comprises a combination of fishmeal and another source of protein.

8. The feed formulation of claim 1, wherein said source of protein comprises a combination of SBM and another source of protein.

9. The feed formulation of claim 1, wherein said source of protein comprises any of wheat gluten and corn gluten.

10. The feed formulation of claim 1, wherein said source of protein comprises an animal byproduct.

11. The feed formulation of claim 10, wherein said animal byproduct is the form of a powder.

12. The feed formulation of claim 1, wherein a concentration of the CSL in the feed formulation is in a range of about 10% to 90%.

13. The feed formulation of claim 1, wherein a concentration of the CSL in the feed formulation is in a range of about 20% to 80%.

14. The feed formulation of claim 1, wherein a concentration of the CSL in the feed formulation is in a range of about 30% to 70%.

15. The feed formulation of claim 1, wherein a concentration of the CSL in the feed formulation is in a range of about 40% to 60%, and optionally about 50%.

16. The feed formulation of claim 1, further comprising at least one of an animal-based or a plant-based oil.

17. The feed formulation of claim 16, wherein said plant-based oil comprises soy bean oil.

18. The feed formulation of claim 16, wherein said animal-based oil comprises fish oil.

19. The feed formulation of claim 1, wherein said source of protein is untreated.

20. The feed formulation of claim 19, wherein said untreated protein comprises untreated soy.
